(19) United States
(12) Patent Application Publication
(10) Pub. No.: US 2011/0313755 A1
(43) Pub. Date: Dec. 22, 2011

(54) MULTILANGUAGE WEB PAGE TRANSLATION SYSTEM AND METHOD FOR TRANSLATING A MULTILANGUAGE WEB PAGE AND PROVIDING THE TRANSLATED WEB PAGE

(76) Inventor: Eui Jin Oh, Daejeon (KR)

(21) Appl. No.: 13/148,310

(22) PCT Filed: Feb. 10, 2010
(86) PCT No.: PCT/KR2010/000838

§ 371 Date: Aug. 6, 2011

(30) Foreign Application Priority Data
Feb. 10, 2009 (KR) 10-2009-0010427

(51) Int. Cl. G06F 17/28

(52) U.S. Cl. 704/3; 704/E11.001

(57) ABSTRACT

A system and method for translating a multilingual web page are provided. The method includes receiving an attempt of a user to access a specific web site through the Internet, grasping in which country a language registered by a user, a language used in an area corresponding to the IP address of the user, a language selected by the user, and a language input by the user are used, and, when a used language is different from a language in which an original text provided by the web page of the web site is written, replacing a translation in which the original text is translated into the language used by the user by the original text of the web page to provide the translation.

### TECHNICAL FIELD

The present invention relates to a system for translating a multilingual web page and a method of translating a multilingual web page to provide a translated web page, and more particularly, to a system for translating a web page written in multi-languages into the language used by a user to provide the translated web page to the user, which is capable of letting a user directly participate in translation to correct a translation and of maintaining the suitability of a corrected content and a method of translating the web page and to provide the translated web page.

### BACKGROUND ARTS

The Internet is widespread and many people acquire and share information through the Internet. It is possible to visit all of the worldwide sites through the Internet so that activities may be made all over the world as a life zone.

However, the site provided by each country is written in the language used by the country. Therefore, when a user in another country visits the site written in a foreign language, the user may obtain no information by visiting the site. Although the user understand the language, since the user may not as rapidly and correctly grasp the meaning of the language as the user grasps the meaning of his or her native language, the user usually visits only the site written in the language used by him or her.

Therefore, although all of the sites of the world may be visited by the Internet, the user visits only the site written in the language used by him or her to obtain information. Therefore, the amount and the level of obtaining information may deteriorate and global exchange through the Internet is limited.

In addition, a specific language may be mechanically translated into the language used by the user. However, since mechanical translation is not actually created by a person who may perform translation, wrong meanings may be transmitted or there may be errors in sentences. Therefore, when a simply mechanical translation is provided to the user, a context is not smooth so that the interest of the user may be reduced and wrong information may be transmitted.

### DISCLOSURE OF INVENTION

### Technical Problems

Therefore, the present invention has been made to solve the above problems, and it is an aspect of the present invention has been made to provide a system for translating a multilingual web page to provide a translated web page, in which the web page of the web site written in another language is converted into the language used by a user to be provided and a method of translating a multilingual web page to provide a translated web page.

The present invention has also been made to provide a system for translating a multilingual web page to provide a translated web page, which is capable of grasping the language used by a user by tracing the registration or the IP address of the user to provide the translation of the web page, and a method of translating a multilingual web page to provide a translated web page.

The present invention has also been made to provide a system for translating a multilingual web page to provide a translated web page, which is capable of a user directly participating in a translation to correct the translation and to maintain the suitability of a corrected content, and a method of translating a multilingual web page to provide a translated web page.

The present invention has also been made to provide a system for translating a multilingual web page to provide a translated web page, in which a text written in a specific language is translated into the languages used by users to be provided, the users may write comments, and the written comments are translated into the languages used by the users to be provided, and a method of translating a multilingual web page to provide a translated web page.

### Technical Solution

In order to achieve the foregoing and/or other aspects of the present invention, there is provided a system for translating a multilingual web page to provide a translated web page, including a web server for providing a web page and a comment translated into a language used by a user to a user terminal, a translating server for translating the web page and the comment requested from the web server into the language used by the user, and a database (DB) for storing information including web page information, comment information, a translation, and a translation correction record.

There is provided a method of translating a multilingual web page to provide a translated multilingual web page, including receiving an attempt of a user to access a specific web site through the Internet, grasping in which country a language registered by a user, a language used in an area corresponding to the IP address of the user, a language selected by the user, and a language input by the user are used, and, when a used language is different from a language in which an original text provided by the web page of the web site is written, replacing a translation in which the original text is translated into the language used by the user by the original text of the web page to provide the translation.

### Advantageous Effects

According to the present invention, the web page of the web site written in another language may be converted into the language used by the user so that, although another language than the used language may not be read but the text written in the different language may be easily grasped.

In addition, it is possible to grasp the text written in another language so that the user may visit all of the web sites over the world to widely and deeply search information.

According to the present invention, it is possible to grasp the language used by the user by tracing the registration or the IP address of the user to provide the translation of the web page so that the translation of the text is automatically provided without the user requesting the translation of the text and that the convenience of the user is improved.

In addition, according to the present invention, the user may directly participate in the translation to correct the translation so that the degree of participation of the user may increases, that the correctness of the translation may be increased due to the participation of the user, and that another user may conveniently and correctly read the translation.

According to the present invention, the text written in a specific language is translated into the languages used by the users, the users may write comments, and the written comments are translated into the used languages to be provided so that the users may exchange opinions and perform discussions with people all over the worlds on the Internet.

### BRIEF DESCRIPTION OF THE DRAWINGS

The objects, features and advantages of the present invention will be more apparent from the following detailed description in conjunction with the accompanying drawings, in which:

FIG. 1 schematically illustrates a system for translating a multilingual web page to provide the translated web page according to an embodiment of the present invention;

FIG. 2 is a block diagram of a web server according to the embodiment of the present invention;

FIG. 3 is a block diagram of a translating server according to the embodiment of the present invention;

FIGS. 4 to 9 are flow charts illustrating a method of translating a multilingual web page according to the embodiment of the present invention to provide the translated web page;

FIGS. 10 to 13 are block diagrams illustrating a pattern in which the method of translating the multilingual web page to provide the translated web page according to the embodiment of the present invention is realized.

### EMBODIMENTS OF INVENTION

Hereinafter, the embodiment of the present invention will be described in detail with reference to the accompanying drawings so that those skilled in the art may easily perform the present invention. In the drawings, in order to clearly describe the present invention, parts that are not related to description are omitted and similar elements are denoted by similar reference numerals throughout the specification.

Throughout the specification, when an element is referred to as “being included”, unless there is anything particularly written to the contrary, it means that other elements are not excluded but may be further included. In addition, the terms of ‘ . . . module’ and ‘ . . . unit’ written in the specification mean units for processing at least one function or operation and may be realized by hardware, software, or a combination of hardware and software.

The present invention relates to a system for translating a multilingual web page to provide the translated web page and a method thereof, and more particularly, to a system for translating a multilingual web page to provide a translated web page, in which a web page written in multi-languages is translated into a language used by a user to provide the translated web page to the user and the user directly participates in translation to correct the translated web page, and a method thereof.

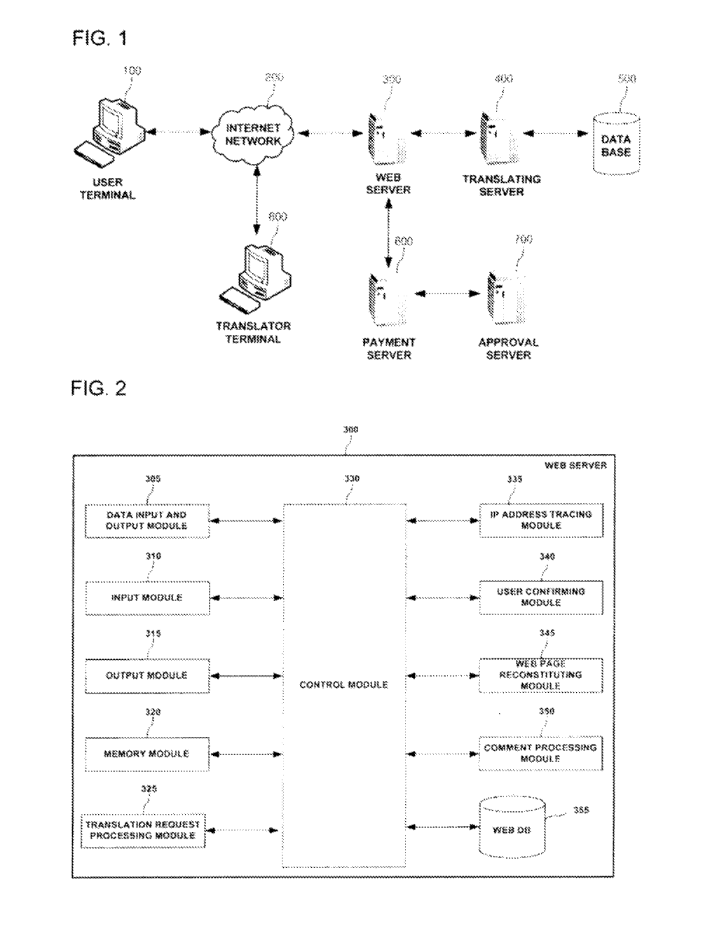

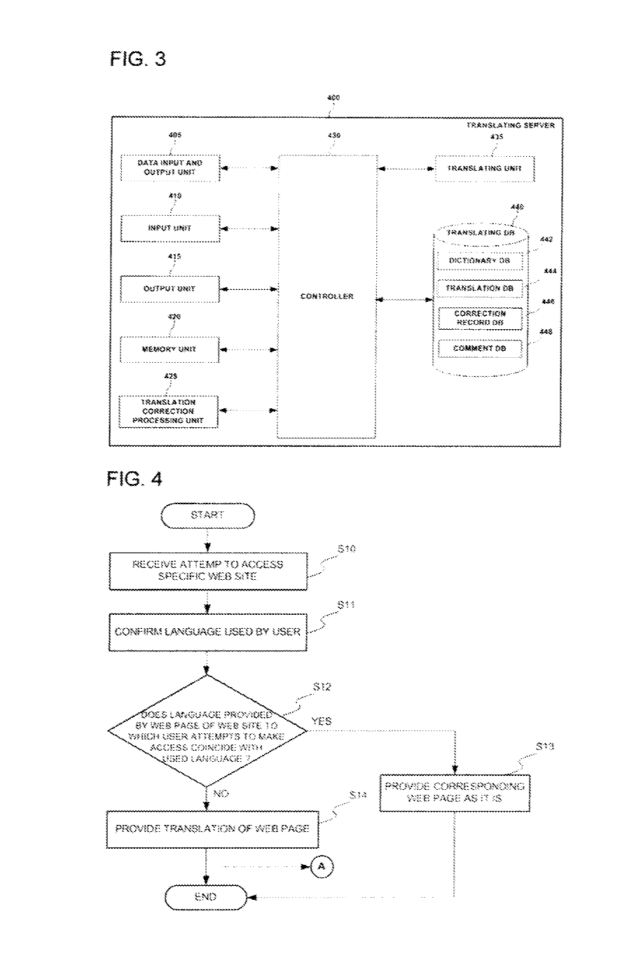

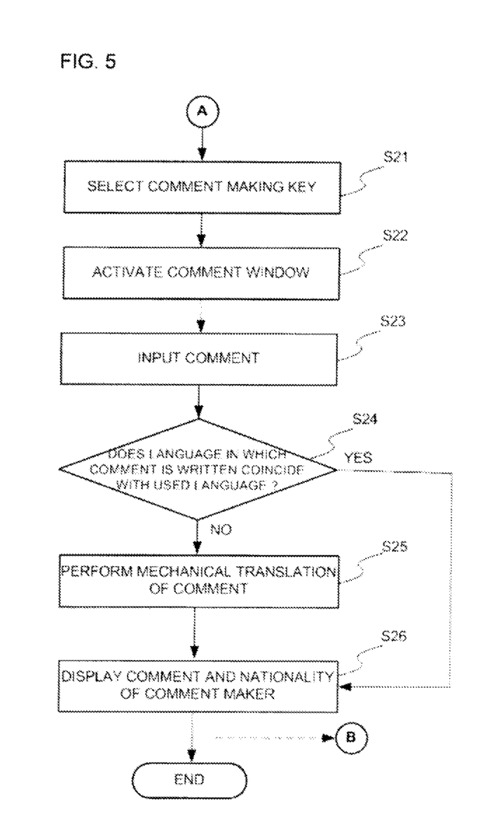

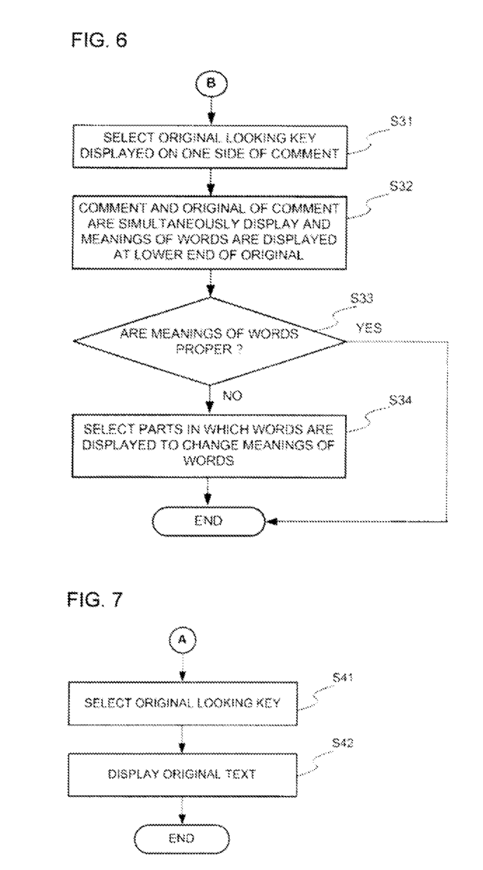

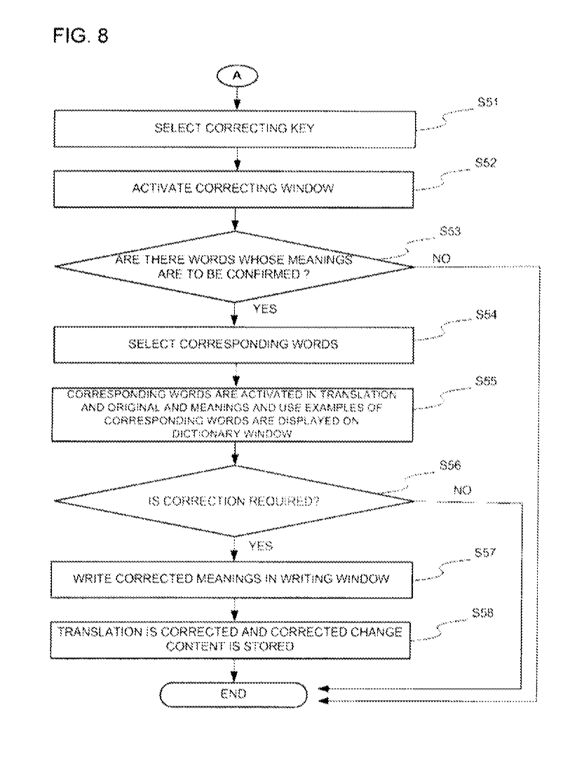

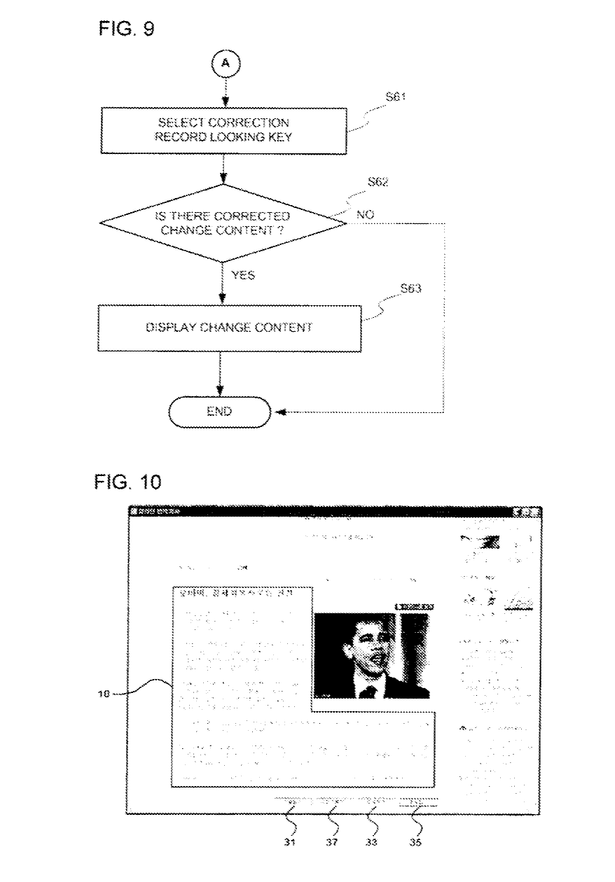

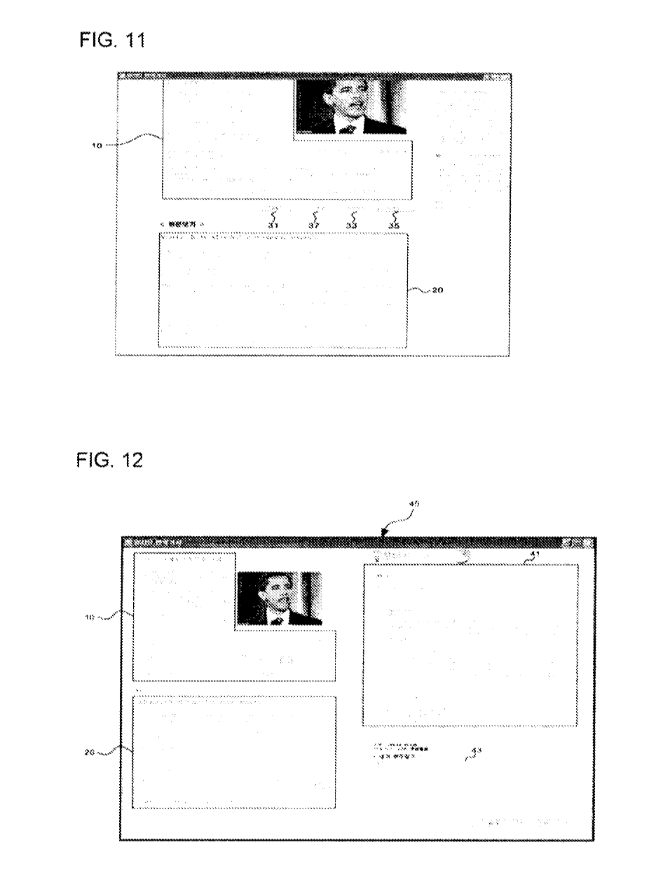

FIG. 1 schematically illustrates a system for translating a multilingual web page to provide the translated web page according to an embodiment of the present invention. FIG. 2 is a block diagram of a web server according to the embodiment of the present invention. FIG. 3 is a block diagram of a translating server according to the embodiment of the present invention. FIGS. 4 to 9 are flow charts illustrating a method of translating a multilingual web page according to the embodiment of the present invention to provide the translated web page. FIGS. 10 to 13 are block diagrams illustrating a pattern in which the method of translating the multilingual web page to provide the translated web page according to the embodiment of the present invention is realized.

FIG. 1 schematically illustrates a system for translating a multilingual web page to provide the translated web page according to an embodiment of the present invention.

The system for translating a multilingual web page to provide a translated web page according to the embodiment of the present invention includes a user terminal 100, an Internet network 200, a web server 300, a translating server 400, a database (DB) 500, a payment server 600, an approval server 700, a translator terminal 800.

The user terminal 100 requests the web server 300 to provide information on a web page and to translate the web page through the Internet network 200 by the input of a user. Here, the web page may be an entire web page and may be an extraction of a partial content. When a correct and professional translation of the web page is desired, the web server 300 or the translator terminal 800 may be requested to translate the web page. Various apparatuses may be used as the user terminal 100. For example, a computer, a laptop computer, a Netbook, a mobile telephone, a smart phone, a personal digital assistant (PDA) may be used as the user terminal 100. Other than the above apparatuses, any apparatus that may be connected to a communication network such as the Internet network 200 may be used as the user terminal 100.

The Internet network 200 connects the user terminal 100, the web server 300, the translating server 400, the payment server 600, the approval server 700, and the translator terminal 800 to each other. The user terminal 100, the web server 300, the translating server 400, the payment server 600, the approval server 700, and the translator terminal 800 transmit data to and receive data from each other through the Internet network 200. For example, the user terminal 100 requests the web server 300 to translate the web page through the Internet network 200 and the web server 300 provides the translated web page to the user terminal 100 through the Internet network 200. Other than the above-described example, various apparatuses transmit data to and receive data from each other through the Internet network 200.

Other than the above-described Internet network 200, the user terminal 100, the web server 300, the translating server 400, the payment server 600, the approval server 700, and the translator terminal 800 may transmit data to and receive data from each other through a mobile communication network.

The web server 300 includes web page information and user information. The user may be confirmed through the user information included in the web server 300. In order to confirm the user, various methods such as a key work and login using user body recognition may be used. The language used by the user, which is previously registered by the user, may be confirmed through the user authentication. When the user does not desire the user confirmation, the web server 300 traces the IP address of the user to grasp an area in which the user accesses the user terminal 100, the language used in the area, and the language used by the user. The web server 300 may grasp the language used by the user by grasping in which country the language input by the user to the user terminal 100 is used.

The web server 300 confirms whether the language used by the user, which is grasped by the above-described method, is the same as the language in which the web page or a comment is written to provide the web page or the comment to the user terminal 100 when the language used by the user is the same as the language in which the web page or the comment is written and to request the translating server 400 to translate the web page or the comment into the language used by the user when the language used by the user is not the same as the language in which the web page or the comment is written. The web server 300 may request the server 400 to translate the web page or the comment into the language selected by the user as well as the language used by the user, which is described above. The web server 300 reconstitutes the web page so that the translation of the web page or the comment transmitted from the translating server 400 is displayed on the web page and provides the reconstituted web page to the user terminal 100. When the web server 300 is requested by the user terminal 100 to correctly and professionally translate the web page or the comment, the web server 300 is, connected to the payment server 600 so that the user may pay translation fees. When the translation fees are paid, the web server 300 requests the translator terminal 800 to translate the web page or the comment. When the translation is free, the web server 300 may request the translator terminal 800 to translate the web page or the comment without being connected to the payment server 600.

The translating server 400 translates the web page or the comment by the language used by the user, which is requested by the web server 300. The translating server 400 translates the web page or the comment by various methods. For example, since the word order of each country varies, the translating server 400 may change the word order of the web page and the comment to be the same as the word order of the language used by the user to translate the web page and the comment. When the web page and the comment may not be once translated into the language used by the user, the web page and the comment may be translated into a designated language to be translated into the language used by the user. The designated language may be designated by the user. Various languages such as the language most widely used by users, the language that may be translated into the language used by the user, and the language that may be most correctly translated into the language used by the user may be used as the designated language. It is preferable to translate the web page and the comment into the language that may be most correctly translated into the language used by the user and then, to retranslate the web page and the comment into the language used by the user. The translating server 400 may be connected to the web server 300 as illustrated in FIG. 1 and may be connected to the Internet network 200.

Data such as the translation of the web page, the translation corrected by the user, the record of the user correcting the translation, the translation performed by the translator terminal 800, a dictionary, the comment, a program, and an operating system (OS) are stored in the DB 500.

Since a correct translation frequently recommended by the users or selected by a web server manager and a translating server manager among the professional translation performed by the translator terminal 800 and the translation corrected by the user is divided into words, sentences, phrases, and a web page to be stored in the DB 500, when the user requests to translate another web page and another comment, the words, the sentences, the phrases, and the web page that constitute the web page and the comment requested by the user are compared with the translation divided into the words, the sentences, the phrases, and the web page stored in the DB 500 so that, when the same words, sentences, phrases, and web page exist, the correct translation stored in the DB 500 may be provided.

The DB 500 may be separately generated from the web server 300 and the translating server 400 as illustrated in FIG. 1, may be integrated with the web server 300, and may be integrated with the translating server 400. In addition, the web server 300, the translating server 400, and the DB 500 may be integrated with each other.

When the user requests the correct and professional translation of the web page, the payment server 600 helps the user to pay the translation fees. The payment server 600 may be connected to the web server 300 as illustrated in FIG. 1 and may be connected to the Internet network 200.

The approval server 700 is connected to the payment server 600 to approve the payment of the fees for the translation requested by the user. The approval server 700 may be connected to the payment server 600 as illustrated in FIG. 1 and may be connected to the web server 300 and the Internet network 200.

The translator terminal 800 performs a correct and professional translation by the request of the user. The translator terminal 800 may be connected to the Internet network 200 as illustrated in FIG. 1 and may be connected to the web server 300 or the translating server 400.

FIG. 2 is a block diagram of a web server according to the embodiment of the present invention.

The web server 300 according to the embodiment of the present invention includes a data input and output module 305, an input module 310, an output module 315, a memory module 320, a translation request processing module 325, a control module 330, an IP address tracing module 335, a user confirming module 340, a web page reconstituting module 345, a comment processing module 350, and a web DB 355.

The data input and output module 305 transmits data to and receives data from the user terminal 100, the translating server 400, the DB 500, the payment server 600, the approval server 700, and the translator terminal 800 through the Internet network 200. For example, the data input and output module 305 of the web server 300 receives data of requesting the translation of the web page from the user terminal 100 and transmits data of requesting the translation to the translating server 400 or the translator terminal 800.

The input module 310 lets the web server manager input data to the web server 300. The output module 315 outputs a result on the data input by the web server manager and the operation result of the web server 300. Since the input module 310 and the output module 315 perform common functions that those who skilled in the art easily know, description of the input module 310 and the output module 315 will be omitted.

The memory module 320 keeps temporary data generated during the operation performed by the web server 300 and stores various programs and OSs required for managing the web server 300.

The translation request processing module 325 compares the language in which the web page is written and the language in which the comment is written with the language used by the user to inform the control module 330 whether the translation is required.

The control module 330 controls the entire operation performed by the web server 300.

The IP address tracing module 335 traces the user IP to grasp the area in which the user access the user terminal 100 when the user is not confirmed by the user confirming module 340 and grasps the language used by the user in the area where the user accesses the user terminal 100. When it is requested by the user to translate the web page and the comment, the web page and the comment are translated into the language used by the user, which is grasped by the IP address tracing module 335, to be provided.

The user confirming module 340 compares the user information stored in the web DB 355 with the user who accesses the user terminal 100 to confirm the user. Various methods such as a key word, the body information of the user, and login may be used for the user confirming module 340 to confirm the user. When the user is confirmed, the language used by the user, which is previously registered by the user, is confirmed. When it is requested by the user to translate the web page and the comment, the web page and the comment are translated into the language used by the user, which is confirmed by the user confirming module 340, to be provided.

The web page reconstituting module 345 reconstitutes the web page so that the translation of the web page or the comment received from the translating server 400 or the translator terminal 800 is displayed on the web page. The web page reconstituting module 345 may reconstitute the web page by various methods in accordance with the input of the user. For example, the web page may be reconstituted by only the translation. When the web page is reconstituted by the translation, only the translation may be displayed on the web page and the translation and the original may be simultaneously displayed on the web page. When the web page is reconstituted only by the translation, the position in which the translation is displayed on the web page may be designated by the user and the translation may be displayed on the place where the original existed. When the web page is reconstituted so that the translation and the original are simultaneously display, the web page may be reconstituted so that the translation and the original are separately displayed on the web page and that the translation and the original are alternately displayed such that one sentence of the original or the translation is displayed and one sentence of the translation or the original corresponding to the displayed sentence of the translation or the original is displayed under the displayed sentence of the translation or the original. The web page may be reconstituted so that one of the translation and the original is displayed on the web page and that, when the user selects or positions a cursor on the words, the sentences, the phrases, or the web page that constitute the translation or the original, the words, the sentences, the phrases, or the web page of the translation or the original corresponding to the words, the sentences, the phrases, or the web page of the translation or the original that are selected or on which a cursor is positioned are displayed.

The comment processing module 350 displays the person who makes the comment when the comment made by the user is displayed on the user terminal 100. For example, the country, the ID, and the nickname of the person who makes the comment may be displayed.

The programs and the information items required for the web server 300 and data such as web page information, user information, and comment information are stored in the web DB 355. The web DB 355 may perform the same functions as the DB 500 and the translating DB 440 of the translating server 400 and may perform different functions.

The web server 300 may include various other elements than the elements described above. For example, the web server 300 may further include a character recognizing module for grasping in which language the characters input by the user is written. Although the user is not confirmed by the user confirming module 340 by using the character recognizing module or the IP address is not traced by the IP address tracing module 335, the language used by the user may be grasped using the characters input by the user. The web server 300 may include various other elements than the above-described character recognizing module.

FIG. 3 is a block diagram of a translating server according to the embodiment of the present invention.

The translating server 400 according to the embodiment of the present invention includes a data input and output unit 405, an input unit 410, an output unit 415, a memory unit 420, a translation correction processing unit 425, a controller 430, a translating unit 435, and a translating DB 440.

The data input and output unit 405 transmits data to and receives data from another apparatus through the Internet network 200 like the data input and output module 305 of the web server 300. For example, a request for translating the web page and the comment is received from the web server 300 and the translations of the web page and the comment are transmitted to the web server 300.

The input unit 410 lets the translating server manager input data to the translating server 400. The output unit 415 outputs a result on the data input by the translating server manager and the operation result of the translating server 400. Since the input unit 410 and the output unit 415 perform common functions that those who skilled in the art easily know, description of the input unit 410 and the output unit 415 will be omitted.

The memory unit 420 keeps temporary data generated during the operation performed by the translating server 400 and stores various programs and OSs required for managing the translating server 400.

When the translation provided by the translating server 400 is corrected by the user, the translation correction processing unit 425 confirms whether the corrected translation is correct to inform the controller 430 whether correction is to be performed. For example, it is confirmed whether abuses or advertisements are written in the translation corrected by the user to confirm whether the translation corrected by the user is correct. It is confirmed whether the meanings of the core contents or the core words of the original are written in the translation corrected by the user to confirm whether the translation corrected by the user is correct. When the meanings of the core contents or the core words of the original are mistranslated or the abuses or the advertisements are written in the translation corrected by the user, since the translation corrected by the user is not correct, the translation is not corrected. When the user wrongly corrects the translation by no less than uniform number of times, the user may not be allowed to correct the translation for a uniform period. Although the translation is correctly corrected, the number of times of previous translation errors may be displayed or the color of the corrected translation is made different so that another user may pay attention. Various other methods may be used for confirming whether the translation corrected by the user is correct and for informing the user who corrected the translation that the translation corrected by the user is not correct may be used than the above-described methods. Since those skilled in the art may easily know the methods, description of the methods will be omitted.

The controller 430 controls the entire operation of the translating server 400.

The translating unit 435 translates the web page and the comment requested to be translated by the web server 300. In addition, the translating unit 435 compares the words, the sentences, the phrases, and the web page that constitute the web page and the comment requested by the web server 300 with the words, the sentences, the phrases, and the web page that constitute the correct translation frequently recommended by the users or confirmed by the web server manager or the translating server manager among the translation translated by the translator terminal 800 stored in the DB 500 or the translating DB 440 and the translation corrected by the user before translating the web page and the comment requested by the web server 300 to provide the words, the sentences, the phrases, and the web page that constitute the translation frequently recommended by the users and the translation confirmed by the web server manager or the translating server manager among the translation translated by the translator terminal 800 stored in the DB 500 or the translating DB 440 and the translation corrected by the user when the same words, sentences, phrases, and web page exist and to provide a mechanical translation when the same words, sentences, phrases, and web page do not exist. The translation of the web page and the comment requested by the web server 300 is provided as the correct translation stored in the DB 500 or the translating DB 440 so that the user may use the correct translation.

The translating DB 440 includes a dictionary DB 442 for storing the meanings and the use examples of a plurality or words that form the translation or a plurality of words that form the original, a translating DB 444 for storing information on the translation of the web page and information on the corrected translation, a correction record DB 446 for storing a correction record when the translation is corrected by the user, and a comment DB 448 for storing the comment input by the user, the translation of the comment, and the corrected translation of the comment. In addition, the translating DB 440 includes a DB for storing various programs and OSs required for managing the translating server 400. The translating DB 440 may further include various other DBs than the above-described DB. The translating DB 440 may perform the same functions as the DB 500 and the web DB 355 and may perform a different function such as a change tracing function so that a difference between a previous translation and a corrected translation may be grasped.

The translating server 400 may further include various other elements than the above-described element.

The DB 500, the web DB 355, and the translating DB 440 may be separated from each other as illustrated in FIG. 1 and may be integrated with each other.

FIGS. 4 to 9 are flow charts illustrating a method of translating a multilingual web page according to the embodiment of the present invention to provide the translated web page.

When the user terminal 100 is connected to the Internet network 200, the user may access a specific web site through the user terminal 100. At this time, in order to access the web site, the corresponding web site address is input to an address window or the web site is searched to select the web site address from a search result.

When the user attempts to access the specific web site, the attempt to make an access is input to the web server 300 for realizing the method according to the embodiment of the present invention (S10).

When the attempt to make an access is input, the user confirming module 340 compares the user information stored in one of the DB 500, the web DB 355, and the translating DB 440 with the user who attempts to access the web site to confirm the user. Various methods such as a key word input, user body information, and login may be used for comparing the user information stored in one of the DB 500, the web DB 355, and the translating DB 440 with the user who attempts to access the web site. When the user information stored in one of the DB 500, the web DB 355, and the translating DB 440 is compared with the user who attempts to access the web site to confirm the user, the user may confirm the language used by the user, which is previously registered by the user.

When the user information stored in one of the DB 500, the web DB 355, and the translating DB 440 is compared with the user who attempts to access the web site to determine that the user is not confirmed or that the user who attempts to access the web site does not desire user confirmation, the IP address tracing module 335 confirms the IP address by which the user currently accesses the Internet. That is, since the position in which the user accesses the Internet may be grasped through the IP address, the language used by the user may be assumed through the position information. Since the IP address varies with an area, the language used by the user may be assumed through the IP address. When the user information is compared with the user to determine that the user is not confirmed or the user does not desire the user confirmation, the web server 300 may assume the language used by the user using the character recognizing module.

The user may select the language used by him or her and may change set information on the realization of the present invention so that the web page of the web site may be displayed by the original in order to have the method according to the embodiment of the present invention is not executed by the web site visited by him or her (S11).

When the language used by the user is grasped using the above-described various methods, it is confirmed whether the language in which the original text 20 provided by the web page of the web site that the user attempts to access is written coincides with the language used by the user (S12). When the language in which the original text 20 provided by the web page is written coincides with the language used by the user, the original text 20 is provided to the user as it is (S13).

When the language in which the original text 20 provided by the web page is written does not coincide with the language used by the user, the original text 20 is translated by the language used by the user by the translating server 400 to generate a translation 10 and the web page reconstituting module 345 reconstitutes the web page so that the translation 10 is replaced by the original text 20 of the web page to provide the reconstituted web page to the user.

At this time, the position in which the translation 10 replaced by the original text 20 is displayed on the web page is not limited. However, it is preferable that the translation be displayed in the same position as the position in which the original text 20 is written in the web page in order to have the corresponding web site seem to be displayed in the language used by the user although the original text 20 is translated to be displayed on the corresponding web page.

For example, as illustrated in FIG. 10, when the user who uses Hangeul accesses the CNN homepage that provides a web page using the English, a Hangeul translation is displayed in the position where the English original of the web page was displayed. Since the Hangeul translation is displayed in the position where the English original was displayed, it seems that the CNN homepage is originally displayed by Hangeul.

The web page reconstituting module 345 may reconstitute the web page so that at least one of a comment making key 31, an original looking key 33, a correcting key 35, a correction record looking key 37, a translation request key (not shown), an on line communication key (not shown) is displayed on the outline of the translation 10. In FIG. 10, the comment making key 31, the original looking key 33, the correcting key 35, and the correction record looking key 37 are displayed on the web page. However, keys that are not frequently used may be deleted or necessary keys may be additionally added by the selection of the user (S14).

The comment making key 31 for writing down an evaluation on the translation 10, an opinion on the content (for example, the content of an article) of the translation 10, and an argument against the evaluation or the opinion is used for activating a comment window (not shown) for inputting the comment on the translation 10.

The user may directly reconstitute the web page. Since the web page is directly reconstituted by the user, information desired by the users may be easily and rapidly found out.

As illustrated in FIG. 10, when the comment making key 31 is selected (S21), a comment window is activated (S22) and the comment may be input to the comment window (S23). When the input of the comment is completed, it is grasped whether the language in which the comment is written coincides with the language used by the user before displaying the written comment (S24). When the language in which the displayed comment is written is different from the language used by the user, the comment is translated into the language used by the user to be displayed (S25).

When the language in which the comment is written is the same as the language used by the user, the language in which the comment is written is displayed as it is.

The comment displayed by the language used by the user is displayed at the lower end of the translation 10. At this time, the input comment is displayed together with the display of the nationality of the user or the country corresponding to the IP address (S26).

For example, since the language used by a Korean who lives in Korea is Hangeul, the corresponding web page displayed in English is translated into Hangeul to be displayed. At this time, when an American who lives in the U.S. makes a comment on the specific article of the web page using the English, the article and the comment are translated into Hangeul to be displayed when the Korean user looks at the article.

In this case, a mark by which the nationality of the American may be grasped, for example, the American flag may be displayed on one side of the comment. Therefore, the Korean user may confirm that the comment is made by an American and that the comment made by the American in English is translated into Hangeul. Various other methods than the above-described method may be used in order to display the nationality of the person who made the comment such as methods of displaying the abbreviation of a country and of displaying the comment by the color of each country.

Since the comment is translated by the translating server 400 to be provided to the user, mistranslation or wrong expression may exist. In order to solve such a problem, an original looking key (not shown) that displays the original of the comment may be displayed on one side of the comment.

When the original looking key (not shown) is selected (S31), the original of the comment is displayed at the lower end of the translated comment and, in the original of the comment, at the lower end of each word, the meaning of the word written in the language used by the user is displayed at the lower end of the word. At this time, the meaning of the language used by the user is referred to in the dictionary to be provided (S32).

As the meaning of the language used by the user is displayed, the user may confirm whether the translation of the comment is correctly performed and may grasp the correct meaning of the comment (S33).

At this time, when the user compares the word of the original with the meaning of the word written in the language used by the user, the user may determine that the meaning of the language used by the user is not contextually proper. In this case, when the part in which the meaning of the language used by the user is displayed is selected, the other meanings of the word may be displayed. The other meanings of the word may be changed in the current position whenever selected to be displayed and may be displayed at the lower end of the word in the form of a scroll bar so that one of the other meanings may be selected (S34).

On the other hand, the original looking key 33 is used for displaying the original text 20 of the translation 10 on a screen. At this time, the original looking key 33 is displayed on one side of the translation 10, for example, at the lower end on the right side and is different from the original looking key with respect to the comment displayed on one side of the comment.

When the original looking key 33 for looking at the original of the translation 10 is selected (S41), the original text 20 of the translation 10 is simultaneously displayed with the translation 10 (refer to FIG. 11) or the original text 20 may be displayed in the position where the translation 10 is displayed.

The original looking key 33 may be selected to simultaneously display the original text 20 and the translation 10 by various methods.

For example, the original text 20 may be displayed on one side of the translation 10 and one sentence of the original text 20 may be displayed and then, the translation 10 of one sentence of the original text 20 may be alternately displayed under one sentence of the original text 20. Since one sentence of the original text 20 and the translation 10 of one sentence of the original text are alternately displayed, the user may easily grasp to which part of the original text 20 the translation 10 is related and may easily grasp whether the original text 20 is correctly translated. When one sentence of the original text 20 and the translation 10 of one sentence of the original text 20 are alternately displayed, the order in which one sentence of the original text 20 and the translation of one sentence of the original text 20 are displayed may be changed by the user.

As an example, when the original text 20 is displayed and the user selects one sentence of the original text 20 or positions a cursor in the one sentence of the original text 20, the translation 10 of the sentence that is selected or in which the cursor is positioned is displayed. The translation 10 may be displayed by a speech bubble on one side of the sentence that is selected or in which the cursor is positioned or may be displayed by generating a space on one side of the sentence that is selected or in which the cursor is positioned. Various other methods than the above-described method may be used in order to display the translation 10 of one sentence of the original text 20 that is selected by the user or in which the cursor is positioned.

As another example, when the user designates the words, the sentences, or the phrases of the translation 10 and selects the original looking key 33, the original text 20 of the words, the sentences, or the phrases designated by the user is displayed. Since the method of displaying the original text 20 is the same as the above-described method, description thereof will be omitted.

As still another example, when the user selects the original looking key 33 selects a specific search word displayed on the translation 10 or inputs a specific search word to an input window to select the original looking key 33, at least one of the original text 20 with respect to the specific search word selected by the user or input to the input window or the original text 20 with respect to the sentence that includes the specific search word is displayed (S42).

In the above, a method of selecting the original looking key 33 from the web page on which the translation 10 is displayed to display the original text 20 on the web page was described. However, the above-described content is applied to the case in which the translation 10 is displayed on the web page where the original text 20 is displayed.

On the other hand, the correcting key 35 is used for activating a correcting window 40 for correcting the wrongly translated part in the translation 10. That is, since the translation 10 is mechanically translated by the translating server 400, the meaning of the word may be translated to be different from a context or the errors of the sentence may be generated. Therefore, in this case, the user may select the correcting key 35 to correct the error of the translation 10.

In detail, when the correcting key 35 is selected (S51), the corresponding translation 10, the original text 20, and the correcting window 40 consisting of a dictionary window 41 for displaying the meanings and the use examples of the words selected from the translation 10 and the original text 20 and a writing window 43 for inputting a text in order to correct the selected words to have other meanings are displayed on the web page (S52). The dictionary window 41 may be generated only when the words are selected and may be simultaneously activated with the writing window 43 in accordance with the set of the user when the words are not selected as illustrated in FIG. 12.

When the word whose meaning is to be confirmed exist in the translation 10 or the original text 20 (S53), the specific word is selected (S54). Then, the corresponding word is activated in the translation 10 and the original text 20 and the meaning and the use example of the word are displayed on the dictionary window 41 (S55). Therefore, the user may grasp whether the corresponding word is properly used while confirming the meaning and the use example of the corresponding word through the dictionary window 41 (S56). When it is determined that the corresponding word is not properly used and that correction is required, the meaning of the word or the sentence may be corrected. Correction is performed by selecting one of the various meanings displayed on the dictionary window 41 or by inputting another meaning of the currently activated word to the writing window 43 (refer to FIG. 12).

In particular, in order to correct the entire sentence, after confirming the plurality of word meanings that constitute one sentence and activating the entire sentence, the sentence corrected by the user is written in the writing window 43 (S57).

When the user writes the corrected sentence in the writing window 43 and corrects the sentence, the translation correction processing unit 425 of the translating server 400 confirms whether the sentence written in the writing window 43 is correct.

For example, the user confirms whether abuses or advertisements are written in the writing window 43. When the abuses or the advertisements are written in the writing window 43, correction is not performed. Various other methods than the above-described method may be used in order to confirm whether the sentence written by the user in the writing window 43 is correct. For example, it may be confirmed whether the sentence written by the user in the writing window 43 is correct by grasping whether the meaning of the core word of the activated sentence is included in the sentence written in the writing window 43 or by confirming whether the abuses or the advertisements stored in the web server 300 and the translating server 400 are included in the sentence written in the writing window 43. Various other methods than the above-described methods may be used in order to confirm whether the sentence input by the user to the writing window 43 is correct.

When it confirmed that the sentence written by the user in the writing window 43 is correct, the translation 10 may be corrected to be changed into a corrected content and to be displayed. After the sentence written by the user in the writing window 43 may be transmitted to the web server 300 and the translating server 400 and the web server manager and the translating server manager confirm the sentence written by the user, the translation 10 may be changed into the content corrected by the user to be displayed. In addition, when the sentence written by the user in the writing window 43 is recommended by no less than uniform number of other users, the translation 10 may be changed into a corrected content to be displayed. In addition, the content of the translation corrected by the user may be seen only by selecting the correction record looking key 37.

The correction history 50 of the translation 10 is stored in a correction record DB 530 in order to confirm which correction history 50 exists in the translation 10 by selecting the correction record looking key 37 (S58).

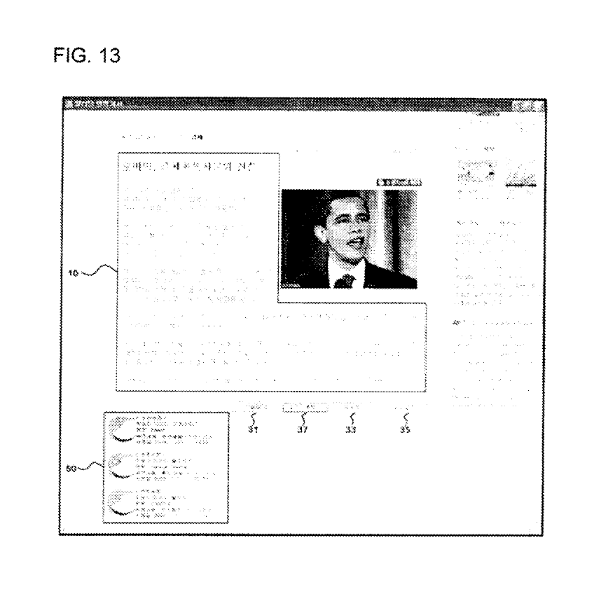

The correction record looking key 37 is used for reading the correction record of the translation 10 stored in the correction record DB 530. That is, when the correction record looking key 37 is selected (S61), it is determined whether the correction history 50 to the present exists in the correction record DB 530 (S62). When it is determined that the correction history 50 exists, the correction history 50 is extracted to be displayed (S63, refer to FIG. 13). The correction history 50 displays at least one information item among a correcting person, correcting time, a corrected part, and a correcting content. Various other information items than the above information items may be displayed in the correction history 50 and the information displayed in the correction history 50 may be changed by the selection of the user. The correction history 50 may be displayed in the empty space of the web page by selecting the correction record looking key 37 as illustrated in FIG. 13 and may be displayed on one side of a corrected word or sentence. In order to display the correction history 50 on one side of the corrected word or sentence, various methods such as a speech bubble and generation of a new space may be used. In addition, a function such as flickering and highlight is provided to the word or sentence having a correction record or a mark such as asterisk is provided to the word or sentence having a correction record so that the user easily know that there is a correction record. The user may select or position a cursor on the word or sentence having the correction record without selecting the correction record looking key 37 to confirm the correction history 50. The user may confirm whether a certain word or sentence is corrected in the translation 10 and may correct the wrong correction performed by another user through the correction history 50. A method of displaying the correction history 50 and a position of displaying the correction history 50 may be changed by the user.

In addition, the correction history 50 may further include a recommending key and a reporting key by which the person who corrected the translation 10 is recommended or reported in accordance with the correction content. The correct translation 10 may be provided to the user through the recommending key and the reporting key. A point may be provided to the person who is frequently recommended and the person who is frequently reported may not be allowed to correct the translation for a uniform period. Recently, since users often answer the question of the user in order to perform advertisements, a space for advertisements may be provide to the person who correctly corrects the translation. Since the space for the advertisements is formed, the users will correctly correct the translation in order to perform advertisements.

The order in which the corrected translation is displayed in the correction history 50 is determined based on one of various references such as a frequently recommended translation, a recently corrected translation, a translation translated by the person who has a high point, a user who corrects the translation designated by the user, and a translation designated by the user.

A translation request key may be further provided at the lower end of the translation 10. The translation request key is used when the original text 20 written by the user in the web page is to be correctly or rapidly translated.

When the translation request key is selected, the word or sentence required to be correctly or rapidly translated may be selected and it may be selected whether to freely receive the translation or to pay translation fees. At this time, the free translation may be requested to the user who has many translation experiences on the Internet. When the corresponding translation is selected so that the user performs translation in accordance with the translation request, a point may be provided to the user.

On the other hand, in the paid translation, the translation of the corresponding text is requested to the professional translator terminal 800. Fees are determined and it may be set so that the translation is requested to the translator terminal 800 only when the corresponding fees are paid.

When an online conversation key is selected, a conversation window is formed so that the user has a conversation with another user while looking at the web page and the conversation input by another user is translated into the language used by the user to be displayed in order to have a smooth conversation with another user.

As described above, according to the present invention, various web pages written in various languages may be freely used without translating the web pages. Since the user may visit the web page written in all of the languages to obtain various information items, a large amount of information may be obtained.

In addition, the translation translated by the translator terminal 800 and the translation corrected by the user are stored in the DB 500, the web DB 355, or the translation DB 440 so that it is possible to provide a correct translation in comparison with the case in which the user terminal requests to translate the web page and the comment.

While this invention has been particularly shown and described with reference to preferred embodiments thereof, these embodiments are provided so that this disclosure will be thorough and complete, and will fully convey the concept of the invention to those skilled in the art. It will be understood by those skilled in the art that various changes in form and details may be made therein without departing from the spirit and scope of the invention as defined by the appended claims.

What is claimed is:

1. A system for translating a multilingual web page to provide a translated web page, comprising:
a web server for providing a web page and a comment translated into a language used by a user to a user terminal;
a translating server for translating the web page and the comment requested from the web server into the language used by the user and for correcting a translation content; and
a database (DB) for storing information including web page information, comment information, a translation, and a translation correction record.

2. The system of claim 1, wherein the web server comprises:
a user confirming module for confirming a user to grasp the language used by the user;
an IP address tracing module for tracing an IP address used by the user to assume the language used by the user; and
a web page reconstituting module for reconstituting a web page.

3. The system of claim 1, wherein the web server further comprises a character recognizing module for recognizing a language input by the user to a user terminal to assume the language used by the user.

4. The system put apparatus of claim 1, further comprising:
a translator terminal for performing a professional translation in accordance with request of a user;
a payment server for paying for fees generated when the user requests the translator terminal to perform translation; and
an approval server for approving fees processed by the payment server.

5. The system of claim 1, wherein the DB divides a correct translation of the professional translation translated by the translator terminal and a translation corrected by the user into words, sentences, or phrases to store the correct translation.

6. The system of claim 1, wherein the translation server comprises:
a translating unit for translating translation requested by the web server into the language used by the user; and
a translation correction processing unit for confirming whether the translation corrected by the user is correct and for processing whether to correct the translation.

7. A method of translating a multilingual web page to provide a translated multilingual web page, comprising:
receiving an attempt of a user to access a specific web site through the Internet;
grasping in which country a language registered by a user, a language used in an area corresponding to the IP address of the user, a language selected by the user, and a language input by the user are used; and
when a used language is different from a language in which an original text provided by the web page of the web site is written, replacing a translation in which the original text is translated into the language used by the user by the original text of the web page to provide the translation.

8. The method of claim 7, wherein, in providing the translation, at least one of a comment making key for activating a comment window for inputting a comment on a translation on the outline of the translation or in a part of a web page, an original looking key for displaying an original text of the translation, a correcting key for activating a correction window for correcting a wrongly translated part in the translation, a correction record looking key for displaying a correction record of the translation stored in a correction record DB, a translation request key for requesting professional translation, and an online conversation key for activating a conversation window for having an online conversation is displayed.

9. The method of claim 8, wherein providing the translation further comprises:
selecting the comment making key to activate a comment window and to input a comment to the comment window; and
displaying the input comment on one side of the translation together with a nationality of the user, a mark of a country corresponding to an IP address, an abbreviation of a user country, or a color for distinguishing a country.

10. The method of claim 9, wherein, when a language in which the displayed comment is written is different from a language used by a user, the comment is translated into the language used by the user to be displayed.

11. The method of claim 10, wherein an original looking key for displaying an original of the comment is displayed on one side of a comment translated to be different from the used language to be displayed.

12. The method of claim 11, wherein, when the original looking key is selected, in the original of the comment, at a lower end of each word, meaning of a used language with respect to the word is displayed.

13. The method of claim 8, wherein, when the original looking key is selected, only an original text is displayed in a web page or the translation and the original text are simultaneously displayed.

14. The method of claim 8, wherein, when the correcting key is selected, a dictionary window for displaying meanings and use examples of words selected from a translation and an original text and a wiring window for inputting a text in order to correct words or sentences to have another meaning are displayed.

15. The method of claim 14, wherein the dictionary window may be generated only when words are selected from the translation or the original text and may be automatically activated in accordance with the setting of a user without selecting words from the translation or the original text.

16. The method of claim 14, wherein, when words are selected from the translation or the original text, corresponding words are activated in the translation and the original text and the meanings and the use examples of the words are displayed on the dictionary window.

17. The method of claim 14, wherein, when the user inputs a correction content with respect to the translation to a writing window, the translation is changed into the content corrected by the user to be displayed and a change history is stored in the correction record DB.

18. The method of claim 14, wherein a correction content with respect to the translation input by the user in the writing window is displayed when the correction record looking key.

19. The method of claim 8, wherein, when the correction record looking key is selected, a change history to the present is extracted from the correction record DB to be displayed.
